(19) United States
(12) Patent Application Publication
(10) Pub. No.: US 2010/0192077 A1
(43) Pub. Date: Jul. 29, 2010

(54) Parent/Child Control System for a Workflow Automation Tool

(75) Inventor: Trisha A. Mochko, Aurora, CO (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/369,338

(22) Filed: Feb. 11, 2009

Related U.S. Application Data
(60) Provisional application No. 61/147,399, filed on Jan. 26, 2009.

(51) Int. Cl. G06F 17/30; G06F 3/048

(52) U.S. Cl. 715/764; 707/E17.009; 707/E17.005

(57) ABSTRACT

In one embodiment according to the teachings of the present disclosure, a computer program generally includes executable code in communication with a record modification source and a workflow automation tool having a database for the storage of a plurality of records. The computer program is operable to receive a first record from the record modification source and determine one or more seconds records from the plurality of records having a parent/child relationship with the first record. The computer program then enforces one or more parent/child rules on the first record relative to the one or more second records and transmits the first record to the workflow automation tool.

### RELATED APPLICATIONS

This application claims priority to U.S. Patent Application Ser. No. 61/147,399, entitled “PARENT/CHILD CONTROL SYSTEM FOR A WORKFLOW AUTOMATION TOOL,” which was filed on Jan. 26, 2009.

### GOVERNMENT CONTRACT

This invention was made in part with United States Government support under Contract No. 99-C-0061. The United States Government may have certain rights in this invention.

### TECHNICAL FIELD OF THE DISCLOSURE

This disclosure relates generally to workflow automation tools, and more particularly, to a parent/child control system for a workflow automation tool and a method of operating the same.

### BACKGROUND OF THE DISCLOSURE

Workflow automation tools generally refer to computer executable systems that are configured to manage workflows in an organization. These workflows may include a number of assigned tasks for members of the organization having various labor skills necessary to accomplish a common goal. The workflow automation tool may be configured to store these assigned tasks as records in a database for review on an as needed or periodic basis. Use of workflow automation tools have grown in acceptance such that records that store workflow information may be integrated with other computer executable systems, such as project scheduling tools or other business management software for increased efficiency and productivity. For example, workflow automation tools may be integrated with source code management (SCM) tools, such as CLEARCASE™ of Rational Software Corporation, to manage computer executable code produced by the organization. When integrated with a source code management tool, the workflow automation tool may be operable to delegate task responsibility to individual members and track these assigned tasks through various revisions of executable software code produced by the organization.

### SUMMARY OF THE DISCLOSURE

In one embodiment according to the teachings of the present disclosure, a computer program generally includes executable code in communication with a record modification source and a workflow automation tool having a database for the storage of a plurality of records. The computer program is operable to receive a first record from the record modification source and determine one or more second records from the plurality of records having a parent/child relationship with the first record. The computer program then enforces one or more parent/child rules on the first record relative to the one or more second records and transmits the first record to the workflow automation tool.

Embodiments of the disclosure may provide numerous technical advantages. Some, none, or all embodiments may benefit from the below described advantages. For example, the computer program provides customization of parent/child rules that may be enforced on records used by the workflow automation tool. Using the computer program, organizations may be able to tailor interactions between parent records and child records according to their specific needs.

Another advantage that may be provided by certain embodiments is enhanced control over various dependencies between and parent records and their associated child records. Records involved in a parent/child relationship with other records having fields with co-dependencies may provide automatic updating of these fields to avoid improper field values or state transitions throughout the extent of the record's active lifespan.

Other technical advantages will be apparent to one of skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is a block diagram showing one embodiment of a parent/child control system according to the teachings of the present disclosure;

FIG. 2 shows several embodiments of various types of records that may be manipulated by the parent child control system of FIG. 1; and

FIG. 3 is a flowchart showing one embodiment of a series of actions that may be performed by the parent/child control system of FIG. 1.

### DETAILED DESCRIPTION OF EXAMPLE EMBODIMENTS OF THE DISCLOSURE

Workflow automation tools organize assigned tasks in a relatively systematic manner to enable visualization of the status of the organization at any point in time. One particular approach for organizing multiple assigned tasks has been to associate records with one another using a parent/child relationship. A parent/child relationship generally associates a parent assigned task with one or more child assigned tasks in which each child assigned task forms a portion of its associated parent assigned task. In one particular example in which the organization produces a computer executable product, a bug in the computer executable product may be recorded in the workflow automation tool as a parent assigned task in a parent record. Work required to fix this bug may include changes to numerous modules such that each module change may be recorded in the workflow automation tool as a child assigned task in a child record.

Due to the inherent complexities of modern computer executable products, initial implementation or modification to existing executable code may yield complex problems with multiple assigned tasks that have been organized in a parent/child relationship. For the example cited previously, multiple modifications to child records from various personnel may cause parent records and/or child records to transition to a confused state, such as a child record transitioning to an “orphaned” state (i.e. having no parent). Other computer executable systems, such as a source code management tool, integrated with the workflow automation tool may worsen the problem by automatically modifying child and/or parent records to restricted states or performing backward state transitions.

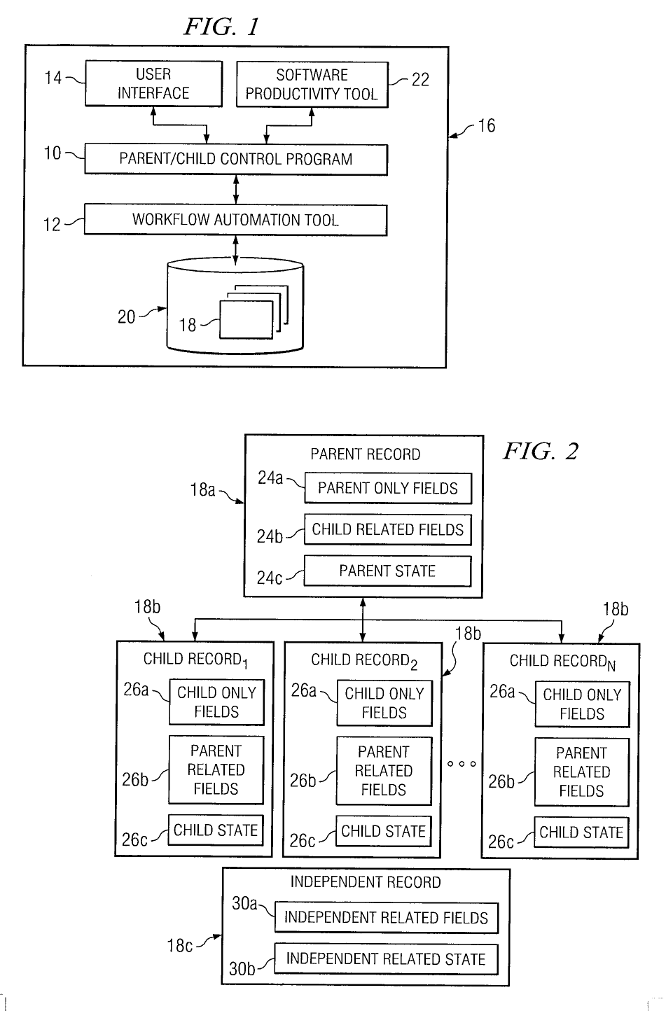

FIG. 1 shows one embodiment of a parent/child control program 10 that may alleviate the previously described problems as well as other problems associated with workflow automation tools. Parent/child control program 10 is coupled between a workflow automation tool 12 and a user interface 14 and is executable on a computing system 16 to receive requests for creation and/or modification of records 18 stored in a database 20. Parent/child control program 10 may also be coupled between workflow automation tool 12 and a software productivity tool 22 to receive requests for creation and/or modification of existing records 18 originating from the software productivity tool 22. As will be described in detail below, parent/child control program 10 may be operable to enforce one or more parent/child rules on requests from user interface 14 or from software productivity tool 22 on records 18 stored by workflow automation tool 12.

Certain embodiments of the present disclosure may provide an advantage in that various relationships among records 18 stored by workflow automation tool 12 may be customized without significant modifications to underlying executable code of the workflow automation tool 12. For example, known workflow automation tools 12 may enable the formation of parent/child relationships among several records 18 to enhance management of these records 18 in an organized manner. To facilitate these parent/child relationships, the workflow automation tool 12 may enforce several rules regarding the relationship between the various records 18. Known workflow automation tools 12, however, do not provide for customization of these rules for use by organizations whose needs may differ from one another. The parent/child control program 10 may provide a solution to this need by enabling customization of parent/child rules that are administered on records 18 that are created or modified by user interface 14 and/or software productivity tool 22. The user interface 14 and/or software productivity tool 22 may be collectively referred to as a record modification sources due to their ability to manipulate records 18 used by the workflow automation tool 12.

Workflow automation tool 12 may be any suitable type of workflow automation tool for managing workflows in an organization using records 18 associated with ordered tasks that describe workflows and associated resources used to accomplish these workflows. In one embodiment, workflow automation tool 12 may be a CLEARQUEST™ automation tool, available from International Business Machines (IBM) of Armonk, N.Y. The CLEARQUEST™ automation tool may be linked with other software productivity tools 22, such as source code management tools or project management tools to enhance coordination of workflows with these various software productivity tools 22. The database 20 used by the workflow automation tool 12 may be any known mechanism for persistent storage of records used by the workflow automation tool 12.

The user interface 14 may be provided for creation of new records 18 or modification of existing records 18 by users of the workflow automation tool 12. The user interface 14 may include a display, such as a cathode ray tube (CRT) or liquid crystal display (LCD) having a graphical user interface (GUI) for visualization of records 18 coupled with one or more input devices, such as a keyboard, and/or a mouse for manipulation of records 18 displayed upon the display. In one embodiment, the GUI may be a standard GUI provided by the workflow automation tool 12, such as a graphical user interface provided by the CLEARQUEST™ automation tool. In another embodiment, the GUI may be a custom GUI implemented with executable code not conventionally provided by the workflow automation tool 12.

The parent/child control program 10 may be coupled to user interface 14 and workflow automation tool 12 using any suitable interface. In one embodiment, a workflow automation tool 12, such as the CLEARQUEST™ automation tool may provide an application program interface (API) that is exposed to the parent/child control program 10 for transmission and receipt of messages to the user interface 14 through the parent/child control program 10.

The parent/child control program 10 may be implemented on any suitable computing system 16 that may be, for example, a network coupled computing system or a stand-alone computing system. In one embodiment, the stand-alone computing system may be any suitable computing system, such as a personal computer, laptop computer, or mainframe computer capable of executing instructions necessary to implement the parent/child control program 10, workflow automation tool 12, and user interface 14 according to the teachings of the present disclosure. In another embodiment, the network computing system may be a number of computers coupled together via a network, such as a local area network (LAN), a metropolitan area network (MAN), or a wide area network (WAN). The parent/child control program 10 implemented on a network computing system may allow several users, such as users of the workflow automation tool 12 to readily manipulate and share records 18 with one another and link these records 18 with other software productivity tools 22.

FIG. 2 shows several embodiments of differing types of records 18 that may be implemented for use with the workflow automation tool 12 and may include a parent record 18a, a child record 18b, and an independent record 18c. Parent record 18a is a particular type of record having an established parent/child relationship with one or more child records 18b. Although parent record 18a is shown having a parent/child relationship with several records, it should be understood that parent record 18a may be established with no child records 18b or may be associated with a relatively large number of child records 18b. Independent record 18c is a type of record having no parent/child relationship with another record 18.

Parent record 18a may include a number of fields 24 that provide information to the workflow automation tool 12 and may include parent only fields 24a, child related fields 24b, and a parent state field 24c. Parent only fields 24a may include information that is not dependent upon information in the child record 18b. For example, parent only fields 24a may include information that may be common to all child records 18b associated in a parent/child relationship with the parent record 18a. Child related fields 24b may include information that is dependent upon information in the child record 18b.

Parent state field 24c may include state information about the parent record 18a and may be configured to have any one of a number of states. For example, parent record 18a may be configured to represent a task, such as a software modification strategy for resolution of a software bug. In one embodiment involving this particular case, parent state field 24c may have one of various values, including a submitted state, an assigned state, an integrated state, a built state, a verified state, and a closed state, that each describe various milestones during the software modification process.

Child record 18b may each have a number of fields 26 that provide information to the workflow automation tool 12 and may include child only fields 26a, parent related fields 26b, and a child state field 26c. Child only fields 26a describe a subset of fields 26 that have information that is not dependent upon information in the parent record 18b and parent related fields 26b may include information that is dependent upon information in the parent record 18b. Child state field 26c may include one of several state values pertaining to its associated child record 18c and may include some, none, or all of the values of its respective parent record 18a.

Independent record 18c may have a number of fields 30 that provide information to the workflow automation tool 12 and may include single related fields 30a and an independent record state field 30b. Independent record 18c may be generally referred to as any type of record 18 that is not established in a parent/child relationship with another record 18. Thus, independent records 18c may be suitable for use when a parent/child association with other tasks or sub-tasks are not needed or desired.

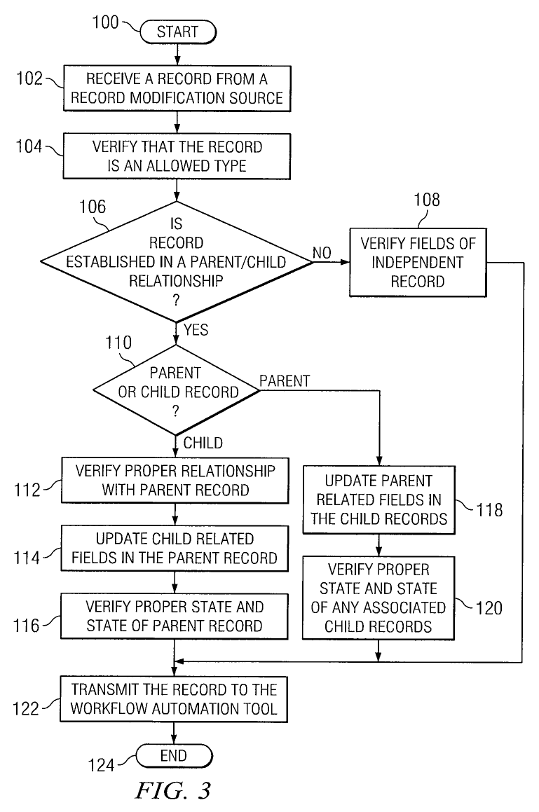

FIG. 3 shows one embodiment of a series of actions that may be performed by parent/child control program 10 to enforce various parent/child rules on records 18 used by workflow automation tool 12. In act 100, the process is initiated. The process may be initiated by launching parent/child control program 10, workflow automation tool 12, user interface 14, and optional software productivity tool 22 on the computing system 16.

In act 102, the parent/child control program 10 may receive a record 18 from the user interface 14 or software productivity tool 22. The record 18 may be a newly created record or a record that has been modified from an existing record 18 stored in the database 20.

In act 104, the parent/child control program 10 may verify that the record 18 is an allowed record type. Records 18 may be any suitable type for use by an organization that uses the workflow automation tool 12. In one embodiment, records 18 may be a parent record 18a, a child record 18b, or an independent record 18c. In another embodiment, records may be only one of a parent record 18a, a child record 18b, or an independent record 18c. That is, each record 18 may not simultaneously be two differing types of records. If the record 18 is not an allowed record type, the parent/child control program 10 may attempt to resolve the invalid record type. In one embodiment, the parent/child control program 10 may resolve the invalid record type by transmitting an error message to the user interface 14 or software productivity tool 22 requesting correction to the invalid record type. In another embodiment, the parent/child control program 10 may resolve the invalid record type by canceling the record 18 and reverting the process back to act 102 in which the user interface 14 or software productivity tool 22 is given the opportunity to submit another record 18 having a proper record type. If the record 18, however, is an allowed record type, processing continues at act 106.

In act 106, the parent/child control program 10 determines if the record 18 is established in a parent/child relationship or if the record is an independent record 18c. If the record is an independent record 18c, processing continues at act 108 in which the parent/child control program 10 may verify various fields 26 of the independent record 18c for valid values. If one or more invalid values are found, the parent/child control program 10 may attempt to resolve the invalid value in a manner similar to actions taken by parent/child control program in act 104. If the independent record 18c has no invalid values, however, the independent record 18c is transmitted to the workflow automation tool 12 in act 122.

If the record is established in a parent/child relationship, however, processing continues at act 110 in which the parent/child control program 10 determines if the record is a child record 18b or a parent record 18a. If the record is a child record 18b, the parent/child control program 10 may verify that the child record 18b has a proper relationship with its associated parent record 18a in act 112. In one embodiment, the parent/child control program 10 may verify proper relationship by ensuring the child record 18b is associated with only one parent record 18a.

In act 114, the parent/child control program 10 may update any child related fields 24b in its associated parent record 18a. For example, the associated parent record 18a may have a child related field 24b, such as an “estimated completion date,” the value of which is dependent upon modification of particular values in the child record 18b. The parent/child control program 10 may be operable to automatically trigger modification of the “estimated completion date” child related field 24b in the parent record 18a in response to modification of one or more associated fields in the child record 18b.

In act 116, the parent/child control program 10 may verify that the child state field 26c and associated parent state field 24c of the parent record 18a have proper state values. For example, records 18 used by an organization may incorporate several states representing various milestones achieved during completion of the associated task. These states may be constrained to occur in a particular order such that one or more organizational guidelines are properly adhered to. The parent/child control program 10 may be operable to verify that the child state 26c only transitions to a state consistent with an allowed order or sequence. Once the parent/child rules of acts 112 through 116 have been enforced, the child record 18b may be transmitted to the workflow automation tool 12 in act 122.

The description of FIG. 3 will now continue with act 110 in which the parent/child control program 10 determines that the record is a parent record 18a. In this case, the parent/child control program 10 may update any parent related fields 26b in any associated child records 18b in act 118.

In act 120, the parent/child control program 10 may verify that the parent state field 24c and associated child state fields 26c of any associated child records 18a have proper state values. In one embodiment, the parent/child control program 10 may be operable to update the parent state field 24c to be equivalent to the child state field 26c of the slowest child record 18b. For example, a particular parent record 18a may be associated with three child records 18b that each have differing state values that are sequential in nature. The parent/child control program 10 may be operable to update the parent state field 24c to a value that is equivalent to the slowest of the three child state values of the three child records 18b. In this manner, the parent record 18a may accurately represent the overall progress of the task represented by the parent record 18a and associated child records 18b in some embodiments. Once the parent/child rules as described in acts 118 and 120 have been enforced, the parent record 18b may be transmitted to the workflow automation tool 12 in act 122.

The previously described series of actions is repeated for each record 18 received by the parent/child control program 10. When use of the parent/child control program 10 is no longer needed or desired, the process may be concluded by halting execution of parent/child control program 10 on the computing system 16.

One embodiment of a parent/child control program 10 has been described that may enable customized control over parent/child relationships in a workflow automation tool 12. The parent/child control program 10 utilizes one or more parent/child rules that verify proper relationships between any records 18 having an established parent/child relationship with other records 18. Using the parent/child control program 10, organizations may be able to tailor various associations between parent records 18a and child records 18b. Furthermore, the parent/child control program 10 may be operable to control any customized state sequences that these parent records 18a and/or child records 18b may undergo throughout completion of their associated tasks.

Although several embodiments have been illustrated and described in detail, it will be recognized that substitutions and alterations are possible without departing from the spirit and scope of the present disclosure, as defined by the following claims.

What is claimed is:

1. A computer program product comprising:
a user interface for displaying information to a user and receiving input from the user;
a workflow automation tool having a database for the storage of a plurality of records; and
executable code embodied on a computer system in communication with the user interface and the workflow automation tool, the code, when executed by the computer system being operable to:
receive a first record from the user interface;
determine one or more second records of the plurality of records having a parent/child relationship with the first record;
enforce a parent/child rule on the first record relative to the one or more second records; and
transmit the first record to the workflow automation tool.

2. A computer program product comprising:
executable code embodied on a computer system in communication with a record modification source and a workflow automation tool having a database for the storage of a plurality of records, the code, when executed by the computer system being operable to:
receive a first record from the record modification source;
determine one or more second records of the plurality of records having a parent/child relationship with the first record;
enforce a parent/child rule on the first record relative to the one or more second records; and
transmit the first record to the workflow automation tool.

3. The computer program product of claim 2, wherein the first record is a child record, the code being operable to enforce a parent/child rule comprising verifying that the child record is associated with only one parent record.

4. The computer program product of claim 2, wherein the first record is a parent record having a parent record state and the one or more second records are one or more child records each having a child record state, the code being operable to enforce the parent/child rule comprising verifying that the parent record state is equivalent to the slowest child record state.

5. The computer program product of claim 2, wherein the code is operable to enforce the parent/child rule comprising verifying that the first record is only one of a parent record type, a child record type, or an independent record type.

6. The computer program product of claim 2, wherein the code is operable to enforce the parent/child rule comprising verifying that a state field of each of the first record and the one or more second records have a proper state value.

7. The computer program product of claim 2, wherein the first record is a parent record and the one or more second records are one or more child records associated with the parent record, the code being operable to enforce the parent/child rule comprising updating one or more parent related fields in each of one or more child records associated with the parent record.

8. The computer program product of claim 2, wherein the first record is a child record and the one or more second records is a parent record, the code being operable to enforce the parent/child rule comprising updating one or more child related fields in the parent record.

9. The computer program product of claim 2, wherein the workflow automation tool is a CLEARQUEST™ computer executable program.

10. The computer program product of claim 2, wherein the record modification source is a user interface.

11. The computer program product of claim 2, wherein the record modification source is a software productivity tool.

12. A method comprising:
receiving a first record from a record modification source;
determining one or more second records from among a plurality of records having a parent/child relationship with the first record, the plurality of records being stored in a database associated with a workflow automation tool;
enforcing a parent/child rule on the first record relative to the one or more second records; and
transmitting the first record to the workflow automation tool.

13. The method of claim 1, wherein enforcing a parent/child rule on the first record further comprises verifying that the first record is associated with only one parent record, the first record being a child record and the parent record being one of the one or more second records.

14. The method of claim 12, wherein enforcing a parent/child rule on the first record further comprises verifying that a parent record state of the first record is equivalent to a slowest child record state of each of the one or more second records, the first record being a parent record and the one or more second records being one or more child records.

15. The method of claim 12, wherein enforcing a parent/child rule on the first record further comprises verifying that the first record is only one of a parent record type, a child record type, or an independent record type.

16. The method of claim 12, wherein enforcing a parent/child rule on the first record further comprises verifying that a state field of each of the first record and the one or more second records have a proper state value.

17. The method of claim 12, wherein enforcing a parent/child rule on the first record further comprises updating one or more parent related fields in each of one or more second records associated with the first record, the one or more second records being one or more child records and the first record being a parent record.

18. The method of claim 12, wherein enforcing a parent/child rule on the first record further comprises updating one or more child related fields in the one or more second records, the first record being a child record and the one or more second records being a parent record.

19. The method of claim 12, wherein receiving a first record from a record modification source further comprises receiving a first record from a user interface.

20. The method of claim 12, wherein receiving a first record from a record modification source further comprises receiving a first record from a software productivity tool.
